(19) United States
(12) Patent Application Publication
(10) Pub. No.: US 2022/0021258 A1
(43) Pub. Date: Jan. 20, 2022

(54) PUMP WITH DIRECT CONNECTION OF STATOR TO PRINTED CIRCUIT BOARD

(71) Applicant: NIDEC GPM GmbH, Auengrund OT Merbelsrod (DE)

(72) Inventor: Frank SCHWAMBERGER, Schleusingen (DE)

(21) Appl. No.: 17/295,467

(22) PCT Filed: Jan. 17, 2020
(86) PCT No.: PCT/EP2020/051080

§ 371 Date: May 20, 2021

(30) Foreign Application Priority Data
Jan. 30, 2019 (DE) 10 2019 102 316.5

(51) Int. Cl. H02K 3/04; H02K 15/06; H02K 15/00

(52) U.S. Cl. CPC H02K 3/04; H02K 2211/03; H02K 15/0068; H02K 15/06

(57) ABSTRACT

A pump includes an electric motor with a rotor rotatably mounted about an axis of rotation and circumferentially surrounding a stator. The stator includes a stator core and coils wound on the stator core. The coils are made from a winding wire with winding wire end sections electrically contacted at an end surface with a printed circuit board. The winding wire end sections, starting from the stator, extend radially outwardly to the axis of rotation and are directly contacted with the printed circuit board via insulation displacement contacts.

### CROSS REFERENCE TO RELATED APPLICATIONS

This is a U.S. national stage of PCT Application No. PCT/EP2020/051080, filed on Jan. 17, 2020, and with priority under 35 U.S.C. § 119(a) and 35 U.S.C. § 365(b) being claimed from German Application No. 102019102316.5, filed Jan. 30, 2019; the entire disclosures of which are hereby incorporated herein by reference.

### 1. FIELD OF THE INVENTION

The present invention relates to a pump and to a method of electrically contacting a stator to a printed circuit board.

### 2. BACKGROUND

Water pumps often feature DC motors. The DC motors comprise a rotor connected to a motor shaft and rotatably mounted in a housing. The rotor is provided with permanent magnets. A stator is arranged in the rotor, which carries a number of windings on an iron core. When suitably controlled, the windings generate a magnetic field that drives the rotor to rotate. The windings are usually wound in three phases and are accordingly provided with three electrical connections through which the windings can be connected to a control unit (ECU). At low power levels, busbars in the form of conductor foils can be used. For higher powers, the winding connection wires are contacted via busbars made of copper sheet.

For the purpose of the geometric description of the electric motor, the axis of rotation or the longitudinal axis of the motor is assumed to be the center axis and axis of symmetry. The rotor is arranged concentrically to the axis of rotation around the stator.

### SUMMARY

Example embodiments of the present disclosure provide pumps each with a contact between windings of a stator and a printed circuit board that is as simple and durable as possible.

Accordingly, a pump according to an example embodiment of the present disclosure includes an electric motor including a rotor which is rotatably supported about an axis of rotation and which circumferentially surrounds a stator. The stator includes a stator core and coils wound on the stator core, the windings being made from a winding wire with winding wire end sections. The winding wire end sections are electrically contacted with a printed circuit board at an end surface. The winding wire end sections extend radially outwards from the stator to the axis of rotation and are directly contacted with the printed circuit board via insulation displacement contacts. The winding wire end sections extend directly radially outwards to be contacted. This arrangement permits simple direct contacting, which significantly simplifies assembly. In addition, the winding wire end sections can be kept short because they do not have to be guided in the circumferential direction, which saves material costs. This also results in a low connection resistance.

Preferably, the insulation displacement contacts are soldered to the printed circuit board. The insulation displacement contacts are preferably IDCs.

In an advantageous example embodiment of the present disclosure, the insulation displacement contacts are evenly distributed in the circumferential and radial directions on the printed circuit board so that the winding wire end sections for all phases are the same or approximately the same length. All phases thus have the same terminal resistance.

Preferably, the stator and the printed circuit board are aligned with their top and bottom surfaces parallel or substantially parallel to each other.

It is preferred if the winding wire end sections extend exclusively in the radial direction and in the direction of the axis of rotation.

Further, an example embodiment of the present disclosure provides a method of electrically contacting a stator of an electric motor of a pump including a printed circuit board. The stator includes a stator core and coils wound on the stator core. The windings are made of a winding wire including winding wire end sections and the winding wire end sections extend parallel or substantially parallel to the longitudinal axis of the pump. The method includes bending the winding wire end sections outward in the radial direction to the longitudinal axis. The stator is placed with respect to the printed circuit board with a predefined axial distance between the top of the printed circuit board and the bottom of the stator and with a defined distance between the longitudinal axis of the stator and the longitudinal axis of the printed circuit board, with the printed circuit board and the stator being aligned with their top and bottom sides parallel or substantially parallel to each other. Ends of the winding wire end sections are inserted and pressed into insulation displacement contacts on the printed circuit board to provide a direct electrical contact. The stator is moved relative to the printed circuit board such that an axial distance is increased and the distance between the longitudinal axes is zero.

The distance between the longitudinal axes is preferably in a range between about 5 mm and about 25 mm, and in particular preferably in the vicinity of about 8 mm. The distance is preferably selected so that the winding wire end sections are within the viewing range of the press-fit tool when they are contacted with the printed circuit board.

The method allows the stator to be contacted with the printed circuit board on a front surface side in a simple manner. Twisting between the stator and the circuit board is not necessary. The offset creates space to press the winding wire end sections into the insulation displacement contacts. A simple bending operation then produces the geometry of the electric motor without placing too much stress on the connection.

The pump is preferably a water pump, in particular a coolant pump for motor vehicles. The pump is preferably a dry-running pump. The printed circuit board is preferably in contact with a pump housing, in particular the printed circuit board is located between the stator and the pump assembly.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a longitudinal section through a portion of a pump with an electric motor.

FIG. 2 is a side view of a stator and printed circuit board in an assembly position.

FIG. 3 is a top view of the arrangement of FIG. 1.

FIG. 4 is a side view of the stator and printed circuit board in an installation position in the electric motor.

### DETAILED DESCRIPTION

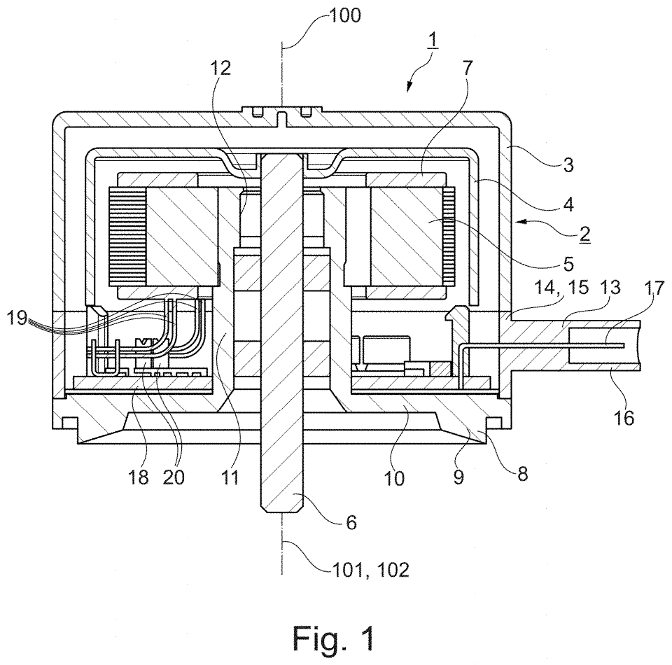

FIG. 1 shows a part of a water pump 1 with an electric motor 2 having a motor housing 3. A rotor 4 and a stator 5 are arranged in the motor housing 3. The rotor 4 surrounds the stator concentrically to an axis of rotation 100. The rotor 4 is connected to a motor shaft 6 to transmit a torque. The water pump 1 is designed as a dry rotor. The electric motor 2 is a brushless DC motor. The stator 5 has a stator core which extends coaxially with respect to the axis of rotation 100 and has a plurality of stator core segments, not shown, around each of which coils 7 are wound. The coils 7 are shown only schematically. The windings are three-phase wound, wherein the windings are formed of a winding wire having winding wire end sections, and the winding wire end sections are frontally contacted electrically with a printed circuit board 18. The stator 5 is fixedly mounted within the motor housing 3 and is adapted to generate a time-varying magnetic field by way of the coils 7. The magnetized rotor 4 surrounds the stator 5 circumferentially. It is arranged to be rotated by interaction with the time-varying magnetic field generated by the coils 7.

The motor housing 3 has a connection for a pump housing 8. The pump housing 8 comprises a housing part 9, which has a base plate 10 and a dome 11 projecting centrally from the base plate 10. The base plate 10 and the dome 11 have a central opening 12 passing through them. The stator 5 sits firmly on the outside of the dome 11. The motor shaft 6 passes through the central opening of the housing part 12 and is rotatably mounted inside the dome 11. Seals, in particular mechanical seals inside the dome 11 guarantee that the fluid to be pumped does not penetrate the electric motor 2. The motor housing 3 sits indirectly or directly on the pump housing 8. The dome 11 forms a heat conduction path.

A plug assembly 13 is provided for connecting the printed circuit board to an electrical control unit. The plug assembly 13 is arranged in the direction of the axis of rotation 100 between the motor housing 3 and the pump housing 8,9. The plug assembly 13 has a substantially cylindrical base body 14 with a jacket 15 and a circular base surface and rests with a first side annularly against the motor housing 3 and with a second side annularly against the pump housing part 9. The plug assembly 13 circumferentially surrounds the circuit board 18. A connection region 16 projects radially outwardly from an outer side of the shell 15, into which contacts 17 for connecting a circuit board 18 to an electrical control device are inserted. The contacts 17 extend through the connection region 16 and project from the inside of the shell 15. The connection area 16 forms a plug.

The contacts 17 are preferably connected to the printed circuit board 18 by forming a press-fit connection. However, conventional solder pin connections or flat solder contacts can also be provided for making the connection.

The plug assembly 13 is injection molded and preferably formed of plastic. The connector assembly can be formed in one piece with the motor housing.

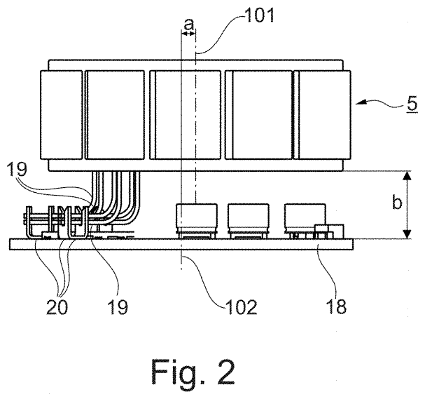

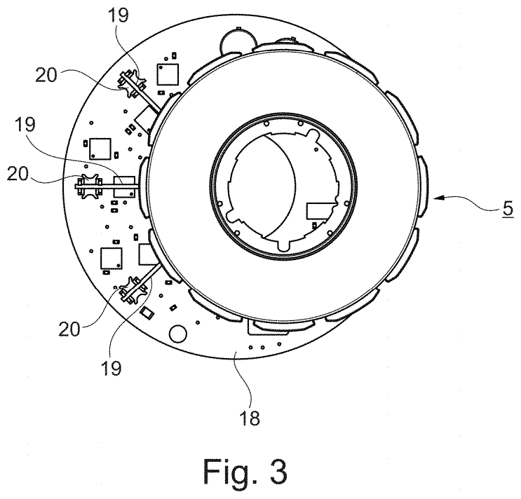

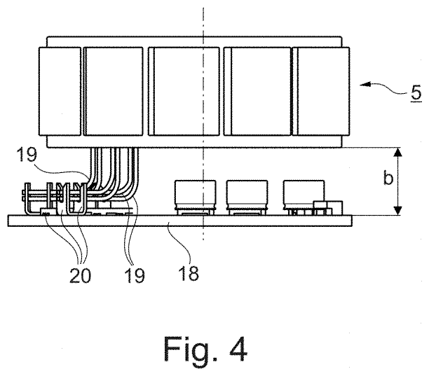

FIGS. 2 to 4 show the assembly and installation position of the stator 5 and the printed circuit board 18. The windings of the stator have winding wire end sections 19 which project from the actual area of the stator at one end face and which are electrically contacted with the printed circuit board 18. The winding wire end sections 19 extend radially outward from the stator 5. They are of approximately equal length for all three phases. Insulation displacement contacts 20, in particular IDC, are arranged, in particular soldered, on the printed circuit board 18 associated with each phase. The winding wire end sections 19 first extend parallel to the axis of rotation and are then angled approximately perpendicular thereto, where they then align along the radius. Bending of the winding wire end sections 19 in the circumferential direction is not provided. The stator 5 and the circuit board 18 are arranged with their upper and lower surfaces parallel to each other. In order to gain sufficient space for inserting and pressing the winding wire end sections 19 into the insulation displacement contacts 20, an offset is provided between the stator 5 and the printed circuit board 18 during assembly. For this purpose, the stator 5 and the printed circuit board 18 are displaced relative to each other, in parallel, so that a distance a results between the longitudinal axis of the stator 101 and the longitudinal axis of the printed circuit board 102. The distance a is preferably in a range between 5 and 25 mm, in particular about 8 mm. Since the winding wire end sections 19 do not have to be bent along the circumference, they can be of the same length and thus have the same resistance.

Due to the distance, the contacts are within the viewing range of the press-fit tool during contacting and the press-fit tool can be arranged above the contacts. When the winding wire end sections 19 are pressed into the insulation displacement contacts 20, the printed circuit board 18 is supported by a tool which rests directly under the printed circuit board 18.

After the winding wire end sections 19 have been pressed into the insulation displacement contacts 20, the axial distance b between the printed circuit board 18 and the stator 5 is increased along the longitudinal axes 101,102 and distance a between the longitudinal axes is equalized and the printed circuit board 18 and the stator 5 are brought into alignment. In the process, the winding wire end sections 19 are slightly bent. In the installation position, the longitudinal axis of the stator 101 and the longitudinal axis of the printed circuit board 102 are then identical.

The printed circuit board and stator assembly can then be further processed. When assembling the pump shown in FIG. 1, the next step is to place the plug assembly 13 on the printed circuit board 18 in the direction of the axis of rotation. Since the plug assembly 13 surrounds the circuit board 18 circumferentially, there is sufficient clearance for soldering the connector contacts 17 to the printed circuit board 18. In a press-fit assembly, on the other hand, there are good support possibilities. In the next assembly step, the stator 5 is pressed onto the dome 11 of the pump housing 8 and centered by way of a centering ring. This assembly step can also be carried out before the connector assembly is placed on the printed circuit board. The printed circuit board 18 is held between the housing part 9 and the plug assembly 13. In a subsequent assembly step, the rotor assembly comprising the rotor 4 and the motor shaft is mounted. In this step, the motor shaft is inserted into the bearing preassembled in the pump housing 8,9. Then the motor housing 3 is placed on the preassembled assembly in the axial direction. Preferably, in a final step, the motor housing 3 and the plug assembly 13, are connected. Preferably, the plug assembly 13 and the pump housing 8,9 are glued together.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-9. (canceled)

10: A pump, comprising:
an electric motor with a rotor which is mounted rotatably about an axis of rotation and which circumferentially surrounds a stator; wherein
the stator includes a stator core and coils wound on the stator core, the coils being made from a winding wire with winding wire end sections, and the winding wire end sections being electrically contacted on an end surface with a printed circuit board;
the winding wire end sections extend radially outwardly from the stator to an axis of rotation and are directly contacted with the printed circuit board via insulation displacement contacts.

11: The pump according to claim 10, wherein the insulation displacement contacts are soldered to the printed circuit.

12: The pump according to claim 10, wherein the winding wire end sections are the same or approximately the same length for all phases.

13: The pump according to claim 10, wherein the stator and the printed circuit board are aligned with their upper and lower sides parallel or substantially parallel to each other when the winding wire end sections are pressed into the insulation displacement contacts.

14: The pump according to claim 10, wherein the winding wire end sections extend in a radial direction and in a direction of the axis of rotation.

15: A method of electrically contacting a stator of an electric motor of a pump with a printed circuit board, the stator includes a stator core and coils wound on the stator core, the coils are formed of a winding wire including winding wire end sections that extend parallel or substantially parallel to a longitudinal axis of the pump, the method comprising:
bending the winding wire end sections outward in a radial direction to the longitudinal axis of the pump;
placing the stator with respect to the printed circuit board such that an axial distance is provided between an upper side of the printed circuit board and a lower side of the stator and with a distance between a longitudinal axis of the stator and a longitudinal axis of the printed circuit board such that the printed circuit board and the stator are aligned with their upper and lower sides parallel or substantially parallel to each other;
inserting and pressing ends of the winding wire end sections into insulation displacement contacts on the printed circuit board; and
moving the stator relative to the printed circuit board such that the axial distance is increased and the distance between the longitudinal axes of the stator and the printed circuit board is zero.

16: The method according to claim 15, wherein the distance between the longitudinal axes of the stator and the printed circuit board is in a range between about 5 mm and about 25 mm.

17: The method according to claim 16, wherein the distance between the longitudinal axes of the stator and the printed circuit board is about 8 mm.

18: The method according to claim 15, wherein the distance between the longitudinal axes of the stator and the printed circuit board is such that the winding wire end sections are located in a visible range of a press-fit tool when contacting the printed circuit board.
